(19) United States
(12) Patent Application Publication
(10) Pub. No.: US 2018/0144584 A1
(43) Pub. Date: May 24, 2018

(54) GAMING APPARATUS AND METHODS

(71) Applicant: TAKARA GAMING SOLUTIONS LIMITED, Kowloon (HK)

(72) Inventors: Yui Man Raymond CHAN, Hong Kong (HK); Ka Lun Ernie SUEK, Hong Kong (HK)

(21) Appl. No.: 15/567,991

(22) PCT Filed: Apr. 21, 2016
(86) PCT No.: PCT/IB2016/052269

§ 371 Date: Oct. 20, 2017

(30) Foreign Application Priority Data
Apr. 21, 2015 (HK) 15103858.8

(51) Int. Cl. G07F 17/32

(52) U.S. Cl. CPC G07F 17/3262; G07F 17/3288; G07F 17/3209; G07F 17/3211; G07F 17/3293

(57) ABSTRACT

A gaming method or apparatus for playing by one host and at least one player and having a set of rules provides at least one feature which is exercisable by a player before making the decision and upon payment or receipt of a valuable consideration. Exercise of the feature by the player is to result in an apparent increase but an actual decrease in average return-to-player or long-term probability of winning by the player after taking into account the valuable consideration paid or received by the player.

### FIELD

The present disclosure relates to gaming apparatus and gaming method.

### BACKGROUND

Many interactive games are available to provide fun, pleasure and sometimes as brain exercises or as an income-earning job. With the advance in telecommunications, interactive games can be played by human players or between human and machine players face-to-face or remotely.

Most interactive games have set rules. It would be beneficial if a player has elected to have more control of a game.

### DISCLOSURE

A game, gaming method and gaming apparatus for playing by one host and at least one player using a set of playing devices is disclosed. The gaming apparatus comprises a controller, a display and a player console for a player to play a game with a host. The game has a set of predefined rules to determine scores of a player and a host, and to determine a win situation and a lose situation by comparing scores of a player and a host. The gaming apparatus is operable to deliver an initial set of player devices corresponding to an initial player total score to the player at beginning of the game for viewing by the player on the display, and the player is to make a decision on whether to make a call for another player device or a next player device after getting the initial set of player devices according to the set of predefined rules.

The controller by execution of a set of stored instructions may make available a feature which is exercisable by the player before the player has to decide on whether to make the call, the feature being exercisable by the player upon payment or receipt of a valuable consideration.

The gaming apparatus is to perform action predefined by the feature upon detection of a signal indicating exercising of the feature by the player, and exercise of the feature by the player is to result in an apparent increase but an actual decrease in average return-to-player or long-term probability of winning by the player after taking into account the valuable consideration paid or received by the player.

The apparatus may operate to display an initial set of host devices representing an initial host total score on the display, the host total score being not known to or not visible by the player before the call is made; wherein a representation of the feature is displayed on the display for user selection and activation via the player console, and the controller is to monitor the player console to detection the signals representing feature exercising and for making the call.

A gaming method comprising a set of predefined rules to determine a win situation and a lose situation by comparing scores of a player and a host is disclosed.

The method comprises giving the player an initial set of player devices representing an initial player total score upon the player paying a wager and the host an initial set of host devices representing an initial host total score at beginning of game, and the player is to decide on whether to make a call for another player device or a next player device after getting the initial set of player devices. The method comprises providing a feature which is exercisable by the player before making the decision and upon payment or receipt of a valuable consideration, and wherein exercise of the feature by the player is to result in an apparent increase but an actual decrease in average return-to-player or long-term probability of winning by the player after taking into account the valuable consideration paid or received by the player.

The game has a set of predetermined rules to determine scores, situations and outcomes. In general, the situations are dependent on the scores and the outcomes are dependent on the situations. The game may have score rules to govern the score to be represented by each playing device, how total scores are determined, what is a higher score, what is a lower score, what is a maximum score and/or a minimum score, what is a busting score, . . . etc. The game may have situation rules to define and determine situations such as what is a win situation, what is a lose situation, what is a tie situation, what is a bust situation, whether a higher score prevails over a lower score or vice versa, and . . . etc. The game may have outcome rules to determine outcomes corresponding to the different situations, for example, pay-outs or rewards in different situations.

A representation of the feature may be displayed on the display for user selection and activation via the player console, and the controller is to monitor the player console to detection the signals representing feature exercising and for making the call.

The method or apparatus may include devising the feature and the value valuable consideration. for example by the controller according to set rules or set calculation, such that the player's probability of winning, expressed in terms of return-to-player, is decreased from a higher initial value to a lower resulting value after exercising the feature.

The set of predefined rules to determine a win situation and a lose situation may comprise a score rule that defines a winning score, a bust situation corresponding to the lose situation when the score is above the winning score, and that a party having a higher score closer to the winning score is at the winning situation; wherein the feature includes the player paying the valuable consideration to decrease the initial score or the player receiving the valuable consideration to increase the initial score.

At least one of the host playing devices may be a covert device hidden from the player and the feature includes a player paying the valuable consideration to view or peek the covert host device.

The feature may include a player paying the valuable consideration to view or peek the next player device to be given to the player if the player decides to request the next player device is made.

The feature may include a player paying the valuable consideration to have the next player device exchanged by redrawn if the next player device received results result in the bust situation of the player.

The set of predefined rules may include a tie situation when scores of the player and the host are the same. The feature may include a player paying the valuable consideration to be in a winning situation or to get back more than the wager when the tie situation arises.

### FIGURES

The present disclosure will be described by way of example and with reference to the accompanying figures, in which:

FIG. 1 depicts an initial playing stage of an example game according to the present disclosure at commencement of the game,

FIG. 2 depicts an example pop-up feature menu associated with a feature selector of the example game of FIG. 1,

FIGS. 3A and 3B depict status of a player hand of the example of FIG. 1 before and after operation of an example feature,

FIGS. 4A and 4B depict status of a player hand of the example of FIG. 1 before and after operation of another example feature,

FIGS. 5A and 5B depict status of a player hand of the example of FIG. 1 before and after operation of another example feature,

FIGS. 6A and 6B depict status of a player hand of the example of FIG. 1 before and after operation of another example feature,

FIGS. 7A and 7B depict status of a player hand of the example of FIG. 1 before and after operation of another example feature,

FIG. 8 is an example flow diagram depicting an example game according to the disclosure,

FIG. 9 is an example flow diagram depicting an example game according to the disclosure,

FIG. 10 is an example flow diagram depicting an example game according to the disclosure,

FIG. 11 is a block diagram depicting a gaming apparatus according to the disclosure,

FIG. 12 is a block diagram depicting a system according to the disclosure, and

FIG. 13 is a diagram showing apparent RTP following use of the features and the base RTP.

### DESCRIPTION

An example game disclosed herein uses a standard 52-card deck as a convenient example of a set of playing devices. A standard 52-card deck comprises 52 playing cards which are arranged into 4 suits, namely, spade, club, heart and diamond. There are 13 cards in each suit which comprises an ‘ace’ or ‘A’ card, 9 numbered cards numbered from 2 to 10, 3 face cards known as King, Queen and Jack.

The rules of a popular game known as basic ‘Blackjack’ or ‘twenty-one’ are incorporated herein by reference.

Blackjack is a game comparing card scores between a player and a host or dealer. It is played with one or more decks of 52 cards. The object of the game is to beat the dealer in one of the following ways:
Get 21 points on the player's first two cards (called a “blackjack” or “natural”), without a dealer blackjack;
Reach a final score higher than the dealer without exceeding 21; or
Let the dealer draw additional cards until his or her hand exceeds 21.

The player or players are dealt a two-card hand and the points of the cards of a player are added to determine score of the player. Face cards (kings, queens, and jacks) are counted as ten points. A player and the dealer can count an ace as 1 point or 11 points. All other cards are counted as the numeric value shown on the card. After receiving their first two cards, players have the option of getting a “hit”, or taking an additional card. In a given round, the player or the dealer wins by having a score of 21 or by having the higher score that is less than 21. Scoring higher than 21 (called “busting” or “going bust”) results in a loss. A player may win by having any final score equal to or less than 21 if the dealer busts. If a player holds an ace valued as 11, the hand is called “soft”, meaning that the player cannot go bust by taking an additional card, since 11 plus the value of any other card will always be less than or equal to 21. Otherwise, the hand is “hard”.

The dealer must hit until the cards have a total score of 17 or more points. In a variation, the dealer also hits on a “soft” 17, i.e. a hand containing an ace and one or more other cards totalling six. A player wins by not busting and having a total score higher than the dealer's. The dealer loses by busting or having a lesser hand than the player who has not busted. If the player and dealer have the same total, this is called a “push” or “tie”, and the player typically does not win or lose money on that hand. One or both of the dealer's cards may be face down at the initial stage when there are two cards.

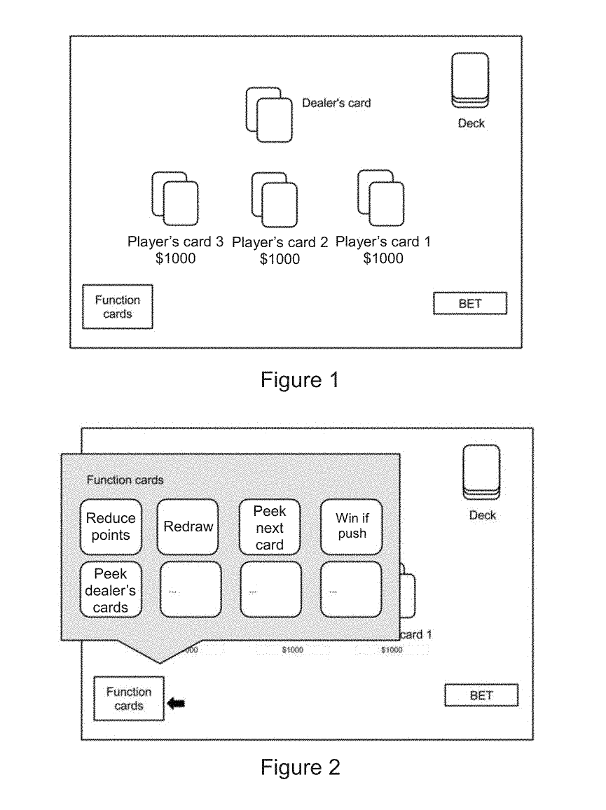

Referring to FIG. 1, 3 players and the dealer are in the game and each one of the 3 players who have contributed a wager and the dealer are dealt two cards each. The total scores of a player at this initial playing stage is the sum of scores of the two cards. The game provides a feature selector which is operable by the player. A plurality of features available for player selection and activation is displayed upon activation of the feature selector. The available features are arranged in the form of a menu comprising arrays of function cards on display, as depicted in FIG. 2. Available features shown in the example menu include: i) ‘win probability’; ii) ‘point reduction’, iii) ‘redraw card on bust’, iv) ‘peek next card’, v) ‘win on push’, and 6) ‘peek dealer's card’. When a player intends to use a feature, the player is to operate the function activator, select a particular feature, and pay a feature activation fee in order to selectively activate the feature.

### ‘View Win Probability’ Feature

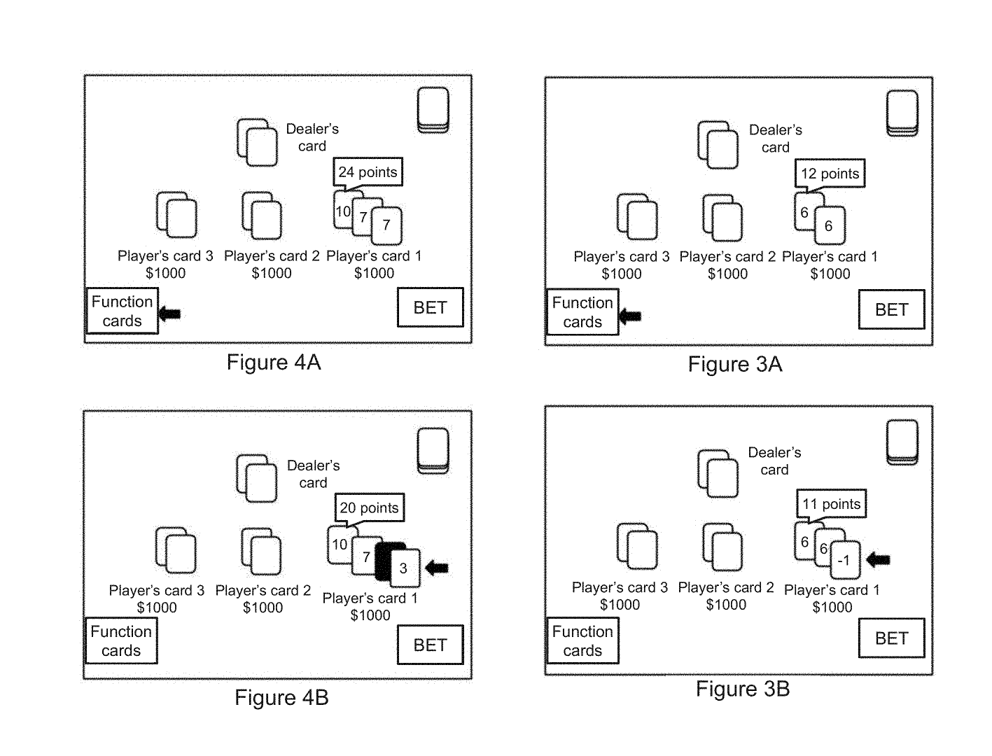

Referring to FIG. 3, a player (player 2 or set 2) intending to activate feature i), i.e., win probability, operates the feature selector and select feature i). Upon paying a feature activation fee, feature i) is activated and winning probabilities are displayed. Two probabilities are generate by a hosting processor and depicted in FIG. 3, namely, probability on hitting (that is, get extra card) and probability on standing (that is, not getting extra card). In some applications, this feature may be exercisable at no fee as a courtesy service.

### ‘Point(s) Reduction’ Feature

Referring to FIG. 4A, a player (player 3 or set 3) upon looking at its two cards, each having 6 points, believes a reduction to a total of 11 points from 12 points would be beneficial and intends to activate feature ii), i.e., point reduction. Upon operating the feature selector to select feature and paying a feature activation fee, feature ii) is activated and one point is deducted from the player's score. The reduction of one point is depicted as a debit card, as depicted in FIG. 4B.

### ‘Redraw Card on Bust’ Feature

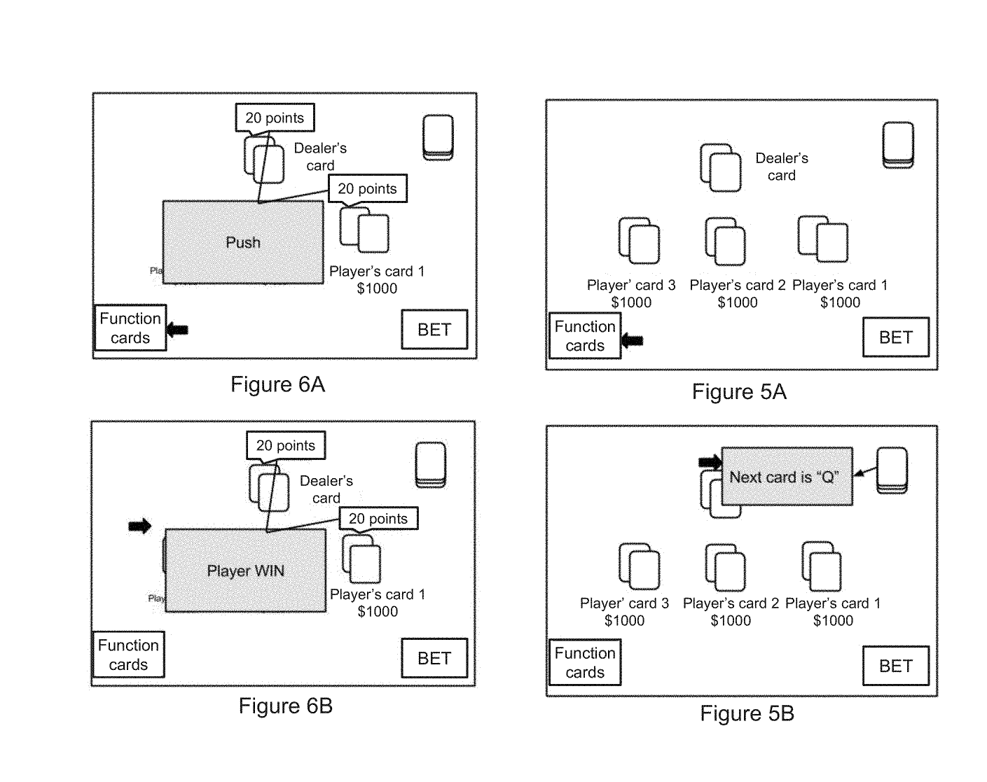

Referring to FIG. 5A, a player (player 3 or set 3) has a total initial score of 17 points after two cards have been dealt. The player elects to use feature iii) before making a request for the next card. Feature iii) is a feature that allows a player to be dealt another card to replace the last dealt card which resulted in apparent busting, and would therefore provide a protection or cover to a player against busting. The third card received by the player as the next card is a 7-point card that brings the total score to the busting score of 24 points. As a result of operation of feature iii), the third card is scrapped and a new card is dealt. The new card is a 3-point card, resulting in a total score of 20 points of the player, as depicted in FIG. 5B.

### ‘Peek Next Card’ Feature

Referring to FIGS. 6A and 6B, a player desirable to know the next card that would be dealt to that player can activate feature iv), i.e., peek next card, in order to discover the score of the next card and decide whether to request for the next card. To achieve this objective, the player will operate the feature selector and select feature iv). Upon payment of the feature activation fee, feature iv) is activated and the next card is displayed or revealed, as depicted in FIG. 6B. The player can then decide whether to request for the next card.

### ‘Win on Push’ or ‘Win on Draw’ Feature

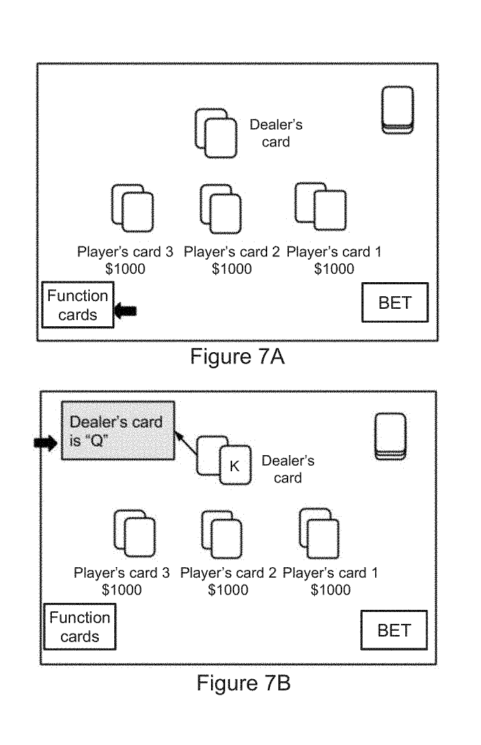

Referring to FIGS. 7A and 7B, a player desirable to improve its position or winning probability so that it will get extra reward, for example double wager back, on a tie situation may activate feature v). Upon payment of the feature activation fee, feature v), i.e., win on push, is activated. If it happens that the dealer and the player have the same total scores, i.e., twenty points as depicted in the example of FIGS. 7A and 7B, the player will receive a payout which is a double of the wager, rather than just the original wager as in the case of the basic game.

### ‘Peek Dealer's Card’ Feature

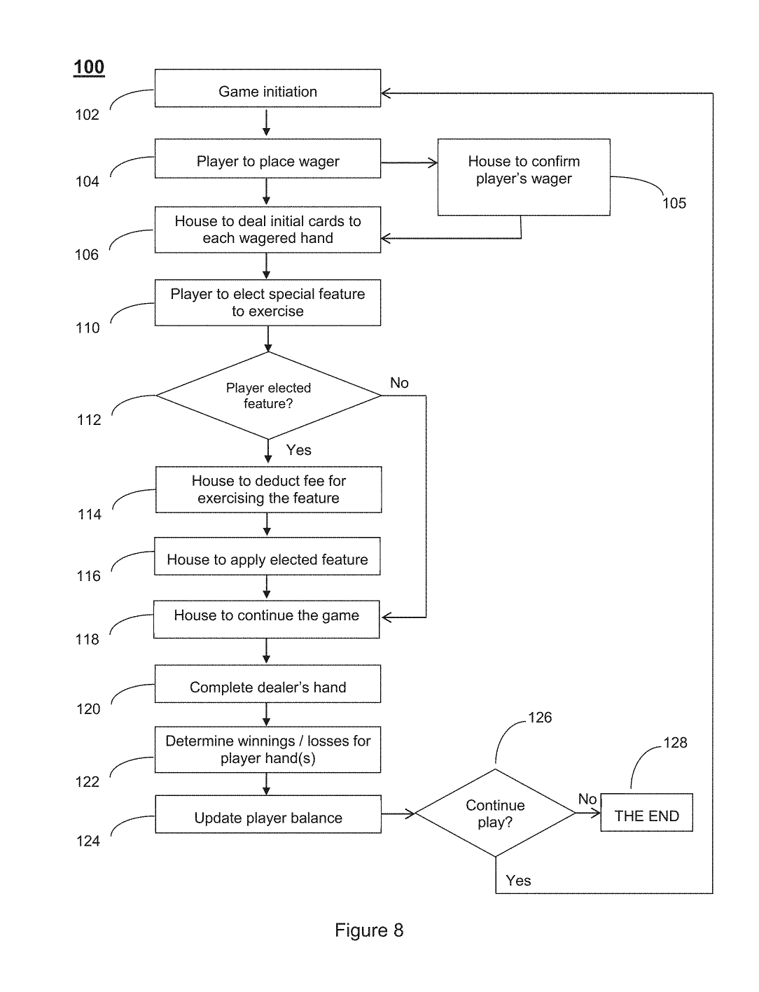

In another example feature as depicted in FIG. 8, the player can use feature vi), i.e., ‘peek dealer's card’ to reveal the face of a hidden card of the dealer and decide whether to order the next card.

In the examples, the three set of cards may be played by three different players, by two different players or a single player playing or without loss of generality.

In the example embodiments, a player has the opportunity of seeing the cards before deciding whether to use a feature.

The example features may be used on its own or in combination with other features as a group of features.

In some embodiments, the game may require a player to decide whether to pay and use a feature before the initial cards are dealt or before the cards dealt are known to the player.

The two alternative schemes, namely, a first adjustment scheme (“Sch. 1”) that a player will need to decide whether to use a feature after the initial cards become visible to the player, and a second adjustment scheme (“Sch. 2”) that a player will need to decide whether to use a feature before the initial cards are visible have different bearings on ‘return-to-player’ (“RTP”) or long term winning probability. The point reduction feature under these two alternative schemes is an adjustment feature which will result in point reduction upon exercise.

Return to Player (‘RTF’) is the term used to describe the percentage of all the wagered money a gaming apparatus such as a VLT (video lottery machine) or a slot machine will pay back to players over time. For example, if a player makes a hundred $1 bets on a machine on which the RTP is 90%, a player might expect to get back about $90 in wins. House advantage and RTP are generally calculated over the long term. Where a host (including a gaming machine or a dealer) has a 20% house advantage, the average RTP will be 80%, meaning that over time the host will keep about 20% of all wager or money bet and will return the other 80% to players in wins.

Table 1 below depicts example RTP associated with the two schemes:

TABLE 1

| | | RTP | RTP |
|---|---|---|---|
| Reduction | Apparent RTP | (Sch. 1) | (Sch. 2) |
| -1 point | 106.31% | 104.93% | 96.86% |
| -2 points | 111.97% | 110.50% | 102.00% |
| -3 points | 115.14% | 113.64% | 104.89% |
| -4 points | 116.38% | 114.86% | 106.02% |
| -5 points | 115.13% | 113.62% | 104.87% |

In the above table, the column ‘Reduction’ means the number of point or points to be reduced upon exercising of the point reduction feature, the column ‘Apparent RTP’ means the apparent long-tern average RTP resulting from the use of the point reduction feature without taking into consideration the fee paid to exercise the feature, the columns ‘RIP (Sch. 1) and ‘RIP (Sch. 2)’ means respectively the actual long-tern average RTP resulting from use of the point reduction feature after taking into consideration the fee paid to exercise the feature under the first adjustment scheme and the second adjustment scheme. The apparent RTP represents substantial increases of RTP when compared to the initial average RTP values of 97.58% of the base, non-featured, game. For example, there is an apparent increase of between 8.73% RTP (−1 points, 106.31%) and 18.8% (−4 points, 116.38%). After taking into consideration the RTP deduction effects of feature fee payments, the apparent RTP values are reduced to the actual RTP values as shown in the columns ‘RIP (Sch. 1) and ‘RIP (Sch. 2)’. While some of the actual RTP values shown in the columns ‘RIP (Sch. 1) and ‘RIP (Sch. 2)’ are above 1 or par, the actual RTP values will change according to the amount of feature fee and the feature fees may be increased to decrease (or may be decreased to increase) the actual RTP payable without loss of generality. The initial average RTP values are long-term average RTP values of the base game without exercising any feature herein.

For example, the actual RTP values according to the second adjustment scheme will change when the feature exercise fee changes from 10% of the wager to 20% of the wager, as depicted in Tables 2-4 below.

While the RTP is above 1 according to Sch. 1, the fee may be adjusted upwards towards the 20% mark to reduce the actual RTP to be on par or below the initial RTP without loss of generality.

TABLE 2

| | | −1 points | | | −2 points | | |
|---|---|---|---|---|---|---|---|
| | | | RTP | RTP | | RTP | RTP |
| | No | | (fee@ | (fee@ | | (fee@ | (fee@ |
| Initial | Feature | RTP | 10% of | 20% of | RTP | 10% of | 20% of |
| Score | RTP | (apparent) | wager) | wager) | (apparent) | wager) | wager) |
| 4 | 0.003741 | 0.004291 | 0.003901 | 0.003576 | 0.004657 | 0.004234 | 0.003881 |
| 5 | 0.009641 | 0.011099 | 0.010090 | 0.009249 | 0.012153 | 0.011048 | 0.010128 |
| 6 | 0.012733 | 0.014720 | 0.013382 | 0.012267 | 0.016114 | 0.014649 | 0.013429 |
| 7 | 0.019089 | 0.021186 | 0.019260 | 0.017655 | 0.022625 | 0.020568 | 0.018854 |
| 8 | 0.025293 | 0.027472 | 0.024974 | 0.022893 | 0.028975 | 0.026340 | 0.024145 |
| 9 | 0.035771 | 0.038318 | 0.034834 | 0.031931 | 0.039953 | 0.036321 | 0.033294 |
| 10 | 0.045347 | 0.047944 | 0.043586 | 0.039954 | 0.049748 | 0.045226 | 0.041457 |
| 11 | 0.056046 | 0.059415 | 0.054014 | 0.049512 | 0.061401 | 0.055819 | 0.051167 |
| 12 | 0.064066 | 0.104526 | 0.095024 | 0.087105 | 0.103156 | 0.093778 | 0.085964 |
| 13 | 0.067726 | 0.077850 | 0.070772 | 0.064875 | 0.108212 | 0.098374 | 0.090176 |
| 14 | 0.060458 | 0.068978 | 0.062707 | 0.057481 | 0.075853 | 0.068957 | 0.063211 |
| 15 | 0.055366 | 0.062457 | 0.056780 | 0.052048 | 0.068244 | 0.062040 | 0.056870 |
| 16 | 0.049762 | 0.052871 | 0.048064 | 0.044059 | 0.055577 | 0.050525 | 0.046314 |
| 17 | 0.053311 | 0.054136 | 0.049215 | 0.045113 | 0.054700 | 0.049728 | 0.045584 |
| 18 | 0.063705 | 0.064253 | 0.058412 | 0.053544 | 0.064620 | 0.058745 | 0.053850 |
| 19 | 0.075771 | 0.075733 | 0.068848 | 0.063111 | 0.075815 | 0.068923 | 0.063179 |
| 20 | 0.160582 | 0.160500 | 0.145909 | 0.133750 | 0.160510 | 0.145918 | 0.133758 |
| 21 | 0.117373 | 0.117393 | 0.106721 | 0.097828 | 0.117380 | 0.106709 | 0.097817 |
| RTP | 0.975780 | 1.063142 | 0.966493 | 0.885952 | 1.119694 | 1.017903 | 0.933078 |

| | | | | | | |
|---|---|---|---|---|---|---|
| House edge | −6.31% | 3.35% | 11.40% | −11.97% | −1.79% | 6.69% |

TABLE 3

| | | −3 points | | | −4 points | | |
|---|---|---|---|---|---|---|---|
| | | | RTP | RTP | | RTP | RTP |
| | No | | (fee@ | (fee@ | | (fee@ | (fee@ |
| Initial | Feature | RTP | 10% of | 20% of | RTP | 10% of | 20% of |
| Score | RTP | (apparent) | wager) | wager) | (apparent) | wager) | wager) |
| 4 | 0.003741 | 0.005195 | 0.004723 | 0.004330 | 0.005133 | 0.004666 | 0.004277 |
| 5 | 0.009641 | 0.012768 | 0.011607 | 0.010640 | 0.013863 | 0.012603 | 0.011553 |
| 6 | 0.012733 | 0.016982 | 0.015438 | 0.014152 | 0.017474 | 0.015885 | 0.014562 |
| 7 | 0.019089 | 0.023508 | 0.021371 | 0.019590 | 0.023931 | 0.021756 | 0.019943 |
| 8 | 0.025293 | 0.029870 | 0.027155 | 0.024892 | 0.030385 | 0.027623 | 0.025321 |
| 9 | 0.035771 | 0.041049 | 0.037317 | 0.034207 | 0.041564 | 0.037786 | 0.034637 |
| 10 | 0.045347 | 0.050900 | 0.046273 | 0.042417 | 0.051523 | 0.046839 | 0.042936 |
| 11 | 0.056046 | 0.062828 | 0.057116 | 0.052356 | 0.063371 | 0.057610 | 0.052810 |
| 12 | 0.064066 | 0.098728 | 0.089753 | 0.082274 | 0.094259 | 0.085690 | 0.078549 |
| 13 | 0.067726 | 0.105474 | 0.095885 | 0.087895 | 0.100419 | 0.091290 | 0.083683 |
| 14 | 0.060458 | 0.100146 | 0.091042 | 0.083455 | 0.096307 | 0.087552 | 0.080256 |
| 15 | 0.055366 | 0.072560 | 0.065963 | 0.060466 | 0.092365 | 0.083968 | 0.076971 |
| 16 | 0.049762 | 0.057802 | 0.052547 | 0.048168 | 0.059306 | 0.053915 | 0.049422 |
| 17 | 0.053311 | 0.055103 | 0.050094 | 0.045919 | 0.055237 | 0.050215 | 0.046031 |
| 18 | 0.063705 | 0.064782 | 0.058893 | 0.053985 | 0.064881 | 0.058983 | 0.054068 |
| 19 | 0.075771 | 0.075793 | 0.068902 | 0.063160 | 0.075805 | 0.068913 | 0.063171 |
| 20 | 0.160582 | 0.160495 | 0.145904 | 0.133746 | 0.160645 | 0.146041 | 0.133871 |
| 21 | 0.117373 | 0.117282 | 0.106620 | 0.097735 | 0.117341 | 0.106674 | 0.097785 |
| RTP | 0.975780 | 1.151265 | 1.046604 | 0.959387 | 1.163812 | 1.058011 | 0.969843 |

| | | | | | | |
|---|---|---|---|---|---|---|
| House edge | −15.13% | −4.66% | 4.06% | −16.38% | −5.80% | 3.02% |

TABLE 4

| | | -5 points | | |
|---|---|---|---|---|
| | No | | RTP | RTP |
| Initial | Feature | RTP | (fee@ | (fee@ |
| Score | RTP | (apparent) | 10% of wager) | 20% of wager) |
| 4 | 0.003741 | 0.004950 | 0.004500 | 0.004125 |
| 5 | 0.009641 | 0.013470 | 0.012245 | 0.011225 |
| 6 | 0.012733 | 0.018560 | 0.016873 | 0.015467 |
| 7 | 0.019089 | 0.023959 | 0.021781 | 0.019966 |
| 8 | 0.025293 | 0.030440 | 0.027673 | 0.025367 |
| 9 | 0.035771 | 0.041619 | 0.037836 | 0.034683 |
| 10 | 0.045347 | 0.051496 | 0.046815 | 0.042914 |
| 11 | 0.056046 | 0.063540 | 0.057764 | 0.052950 |
| 12 | 0.064066 | 0.088723 | 0.080657 | 0.073936 |
| 13 | 0.067726 | 0.095063 | 0.086421 | 0.079219 |
| 14 | 0.060458 | 0.090358 | 0.082144 | 0.075299 |
| 15 | 0.055366 | 0.087629 | 0.079663 | 0.073024 |
| 16 | 0.049762 | 0.067483 | 0.061348 | 0.056236 |
| 17 | 0.053311 | 0.055278 | 0.050252 | 0.046065 |
| 18 | 0.063705 | 0.064907 | 0.059006 | 0.054089 |
| 19 | 0.075771 | 0.075791 | 0.068901 | 0.063159 |
| 20 | 0.160582 | 0.160567 | 0.145970 | 0.133806 |
| 21 | 0.117373 | 0.117374 | 0.106704 | 0.097812 |
| RTP | 0.975780 | 1.151207135 | 1.046552 | 0.959339 |

| | | | |
|---|---|---|---|
| House edge | −15.12% | −4.66% | 4.07% |

Likewise, the actual RTP values for other features will change when the feature exercise fee changes from 10% of the wager to 20% of the wager, as depicted in Tables 5 and 6 below.

TABLE 5

| | | After using ‘redraw card on bust’ | | | After using ‘peek next card’ | | |
|---|---|---|---|---|---|---|---|
| | | | RTP | RTP | | RTP | RTP |
| | No | | (fee@ | (fee@ | | (fee@ | (fee@ |
| Initial | Feature | RTP | 10% of | 20% of | RTP | 10% of | 20% of |
| Score | RTP | (apparent) | wager) | wager) | (apparent) | wager) | wager) |
| 4 | 0.003741 | 0.004370 | 0.003973 | 0.003642 | 0.004338 | 0.003944 | 0.003615 |
| 5 | 0.009641 | 0.011400 | 0.010364 | 0.009500 | 0.011511 | 0.010464 | 0.009592 |
| 6 | 0.012733 | 0.015173 | 0.013794 | 0.012644 | 0.015709 | 0.014281 | 0.013091 |
| 7 | 0.019089 | 0.021340 | 0.019400 | 0.017784 | 0.023291 | 0.021174 | 0.019409 |
| 8 | 0.025293 | 0.027634 | 0.025122 | 0.023029 | 0.029501 | 0.026819 | 0.024584 |
| 9 | 0.035771 | 0.038467 | 0.034970 | 0.032056 | 0.040546 | 0.036860 | 0.033789 |
| 10 | 0.045347 | 0.048222 | 0.043838 | 0.040185 | 0.050454 | 0.045868 | 0.042045 |
| 11 | 0.056046 | 0.059478 | 0.054070 | 0.049565 | 0.062969 | 0.057245 | 0.052474 |
| 12 | 0.064066 | 0.082225 | 0.074750 | 0.068521 | 0.098036 | 0.089123 | 0.081696 |
| 13 | 0.067726 | 0.083843 | 0.076221 | 0.069869 | 0.099063 | 0.090057 | 0.082552 |
| 14 | 0.060458 | 0.075149 | 0.068318 | 0.062624 | 0.089466 | 0.081332 | 0.074555 |
| 15 | 0.055366 | 0.068460 | 0.062236 | 0.057050 | 0.082088 | 0.074625 | 0.068407 |
| 16 | 0.049762 | 0.056401 | 0.051274 | 0.047001 | 0.065420 | 0.059473 | 0.054517 |
| 17 | 0.053311 | 0.054258 | 0.049325 | 0.045215 | 0.071203 | 0.064730 | 0.059336 |
| 18 | 0.063705 | 0.064294 | 0.058449 | 0.053578 | 0.075590 | 0.068718 | 0.062992 |
| 19 | 0.075771 | 0.075788 | 0.068899 | 0.063157 | 0.084129 | 0.076481 | 0.070107 |
| 20 | 0.160582 | 0.160580 | 0.145982 | 0.133817 | 0.176286 | 0.160260 | 0.146905 |
| 21 | 0.117373 | 0.117364 | 0.106694 | 0.097803 | 0.113022 | 0.102747 | 0.094185 |
| RTP | 0.975780 | 1.064448 | 0.967680 | 0.887040 | 1.192621 | 1.084201 | 0.993851 |

| | | | | | | |
|---|---|---|---|---|---|---|
| House edge | −6.44% | 3.23% | 11.30% | −19.26% | −8.42% | 0.61% |

TABLE 6

| | | After using | | | After using | | |
|---|---|---|---|---|---|---|---|
| | | ‘win on draw’ | | | ‘peek dealer's card’ | | |
| | | | RTP | RTP | | RTP | RTP |
| | No | | (fee@ | (fee@ | | (fee@ | (fee@ |
| Initial | Feature | RTP | 10% of | 20% of | RTP | 10% of | 20% of |
| Score | RTP | (apparent) | wager) | wager) | (apparent) | wager) | wager) |
| 4 | 0.003741 | 0.004047 | 0.003679 | 0.003373 | 0.004017 | 0.003651 | 0.003347 |
| 5 | 0.009641 | 0.010401 | 0.009455 | 0.008667 | 0.010480 | 0.009527 | 0.008734 |
| 6 | 0.012733 | 0.013731 | 0.012483 | 0.011443 | 0.014014 | 0.012740 | 0.011678 |
| 7 | 0.019089 | 0.021296 | 0.019360 | 0.017746 | 0.020570 | 0.018700 | 0.017141 |
| 8 | 0.025293 | 0.028093 | 0.025539 | 0.023411 | 0.026605 | 0.024187 | 0.022171 |
| 9 | 0.035771 | 0.039512 | 0.035920 | 0.032927 | 0.036804 | 0.033458 | 0.030670 |
| 10 | 0.045347 | 0.049707 | 0.045189 | 0.041423 | 0.045914 | 0.041740 | 0.038262 |
| 11 | 0.056046 | 0.060130 | 0.054664 | 0.050109 | 0.057713 | 0.052467 | 0.048095 |
| 12 | 0.064066 | 0.068813 | 0.062557 | 0.057344 | 0.072409 | 0.065826 | 0.060341 |
| 13 | 0.067726 | 0.072349 | 0.065772 | 0.060291 | 0.075660 | 0.068781 | 0.063050 |
| 14 | 0.060458 | 0.064310 | 0.058464 | 0.053592 | 0.068234 | 0.062031 | 0.056861 |
| 15 | 0.055366 | 0.058628 | 0.053298 | 0.048857 | 0.063210 | 0.057464 | 0.052675 |
| 16 | 0.049762 | 0.051553 | 0.046866 | 0.042961 | 0.056777 | 0.051615 | 0.047314 |
| 17 | 0.053311 | 0.062075 | 0.056431 | 0.051729 | 0.057401 | 0.052183 | 0.047834 |
| 18 | 0.063705 | 0.072420 | 0.065836 | 0.060350 | 0.064895 | 0.058995 | 0.054079 |
| 19 | 0.075771 | 0.083730 | 0.076119 | 0.069775 | 0.075287 | 0.068442 | 0.062739 |
| 20 | 0.160582 | 0.177703 | 0.161548 | 0.148086 | 0.153544 | 0.139585 | 0.127953 |
| 21 | 0.117373 | 0.120036 | 0.109123 | 0.100030 | 0.117601 | 0.106910 | 0.098001 |
| RTP | 0.975780 | 1.058534 | 0.962304 | 0.882112 | 1.021134 | 0.928304 | 0.850945 |

| | | | | | | |
|---|---|---|---|---|---|---|
| House edge | −5.85% | 3.77% | 11.79% | −2.11% | 7.17% | 14.91% |

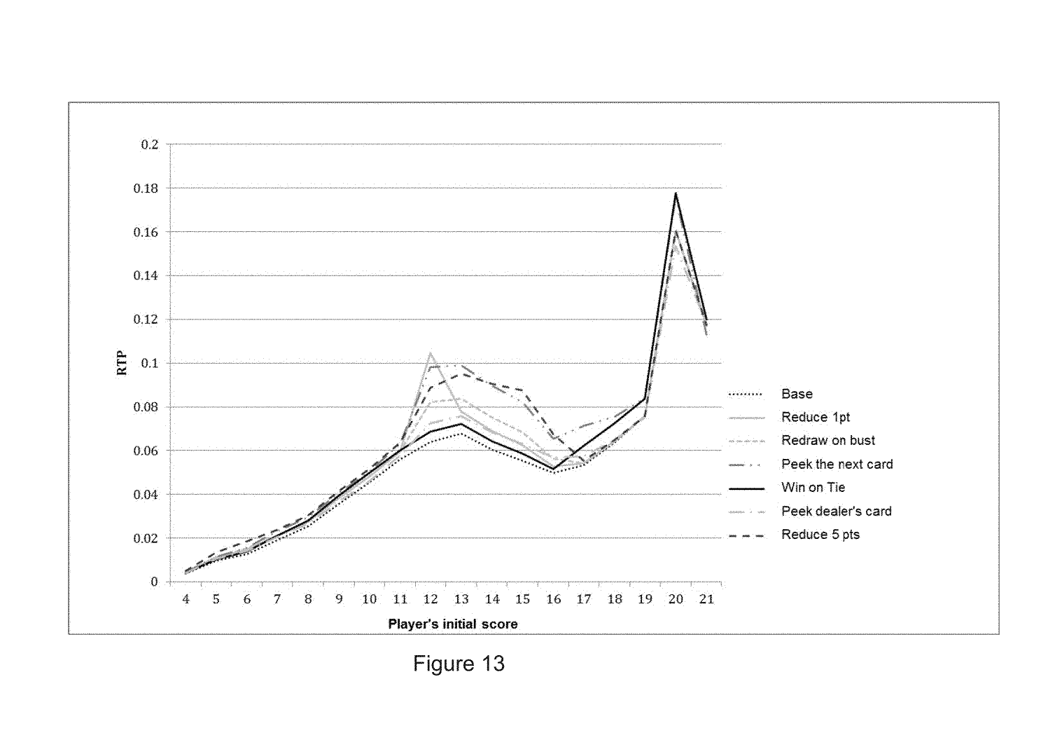

FIG. 13 is a diagram showing apparent RTP following use of the features and the base RTP. For example, in an example scenario below:
Dealer initial set: Face up 9+Face down 7=Total 16
Player initial set: 10+5=15
Next card: J

A usual approach of the player would be a ‘HIT’. However, the player will burst and be in a lose situation if such an approach is taken. On using the “peek dealer card” feature at the premium of the feature fee, the player would know that the initial total score of the dealer hand is 16 points and the dealer must HIT, and this will result in a bust situation of the dealer if the next card is 6, 7, 8, 9, 10, J, Q or K. Upon knowing that there is a 8/13 chance that the next card for the dealer will result in dealer's burst or bust, the player will choose STAND and win.

The game is to be played between at least one player and a dealer which is also known as the ‘house’ or ‘host’. The house is responsible for despatching cards to a player or a plurality of players after a player has made a valuable contribution called a ‘wager’. A wager may be in the form of cash, currency, convertible notes, or other kinds of valuable consideration without loss of generality.

The probabilities referred to herein as ‘return-to-player’ and ‘house advantage’ are related by the relationship: ‘house advantage’=1−‘return-to-player’ are referred to herein.

Referring to FIG. 8, an example game 100 begins at 102 when the player has contributed a wager at 104. The house will confirm receipt of wager 105 and issue initial cards to the player at 106. After the initial cards have been delivered, the house will determine at 110 whether a feature is available or features are available to the player as well as the consideration payable by the player in exchange for the right to exercise a feature or a combination of features. Upon receipt of the initial set of cards, the player will decide at 112 whether to purchase a feature or a combination of features (if allowed) apparently to alter the house advantage. After the feature or the combination of features has been elected, the player will pay the consideration at 114 and the house will perform action specified by the feature and modify the game of the player at 116, and then issue a further card to the player at 118 to continue the game.

After the further card has been issued to the player at 118, the house will at 120 complete the dealer's hand and determine outcome of the game at 122. Player's balance will be updated at 124 when this game cycle ends and the player will decide whether to play another round of the game at 126. The game 100 will end if the player does not wish to proceed further.

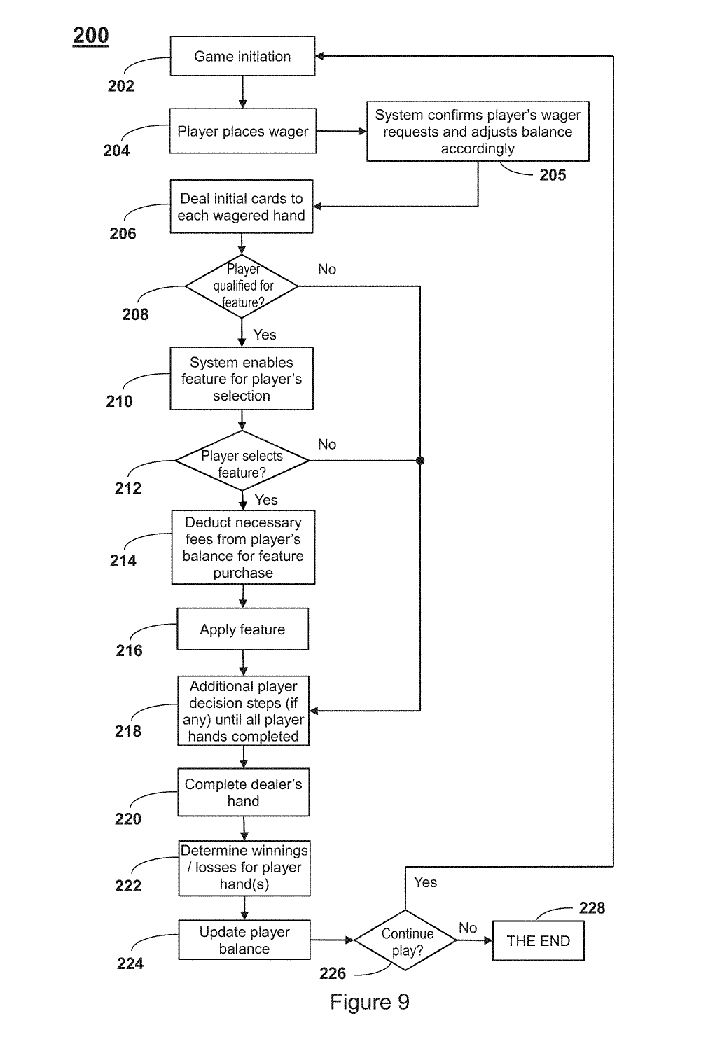

In an example game 200 depicted in FIG. 9, the player needs to be qualified before a feature is available for election by the player and the house will only make available a feature to the player upon the player satisfying prerequisite qualification requirements. Example qualification requirements include advancing to a certain stage of the game or having cumulated a predetermined amount of score. The game depicted in FIG. 9 is substantially identical to that of FIG. 8 plus additional steps to apply additional features and qualification requirements.

Referring to FIG. 9, the game 200 comprises starting the game at 202, inviting the player to place a wager or wagers on up to a maximum of three initial hands at 204, confirming whether the player has sufficient fund for the wager(s), and subtracting the wager(s) from account balance of the player and confirm the placement of bets at 205, dealing initial cards to each wagered player hand and the dealer hand at 206, determining whether the player is qualified to access special feature(s) at 208 according to the stage the player is in (Level 1 to 6), and verifying which feature(s), if any, is qualified by the player and enable the feature(s) for player selection at 210, deducting necessary fees from the player at 214 if the player selects an available feature at 212, and then applying the purchased feature to the existing game hands at 216. The game play will then proceed according to the pre-defined basic game rules at 218, completing game play for each wagered hand according to the pre-defined basic game rules in case the player decides not to purchase any special feature at 218, proceeding to completing the dealer hand as well upon completion of each wagered player hand at 220, calculating winning amount, if any, for each wagered player hand at 222, updating the player account balance at 224, inviting the player to wager again for the next game play at 226, and re-starting the game cycle from 200 if the player decides to continue game play.

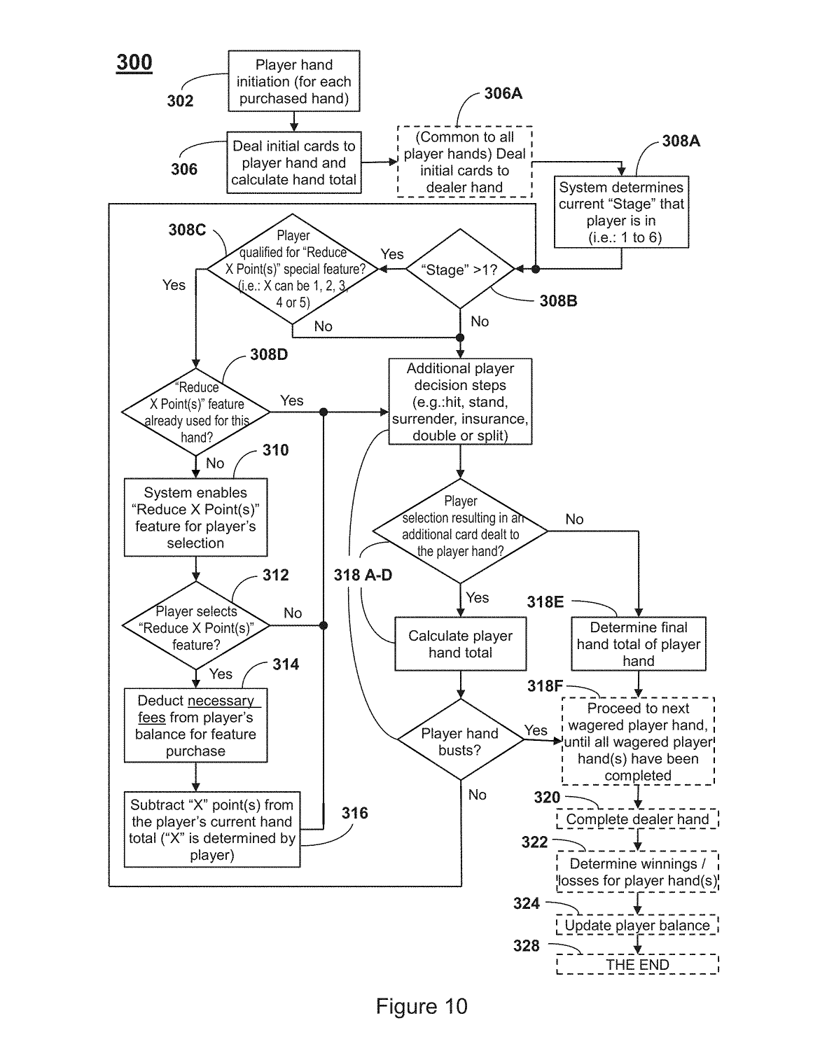

In an example game 300 depicted in FIG. 10, the game begins with the player contributing a wager at 302 and the house issuing initial cards to the player at 306. In this example flow, additional players may partake as an option and the house is to issue initial cards or dealer's hand to the other players who have contributed wagers at 306A. At 308A, the host will determine the proficiency status of the player according to a pre-set of rules for determining the player's level or stage. If the player is found at 308B to have achieved a predetermined threshold level, the house will make available options for election by the player. In this example, the feature 308C is to reduce n points, where n is an integer between 1 and 5.

The game 300 is substantially identical to that of the games 100 and 200, and like numerals denote like steps or elements. For example, the step 310 for enabling the feature “Reduce X Point(s)” is similar to the steps 110 and 210 of the games 100 and 200, while the steps 318A-F related to additional player decision steps are similar to the steps 118 and 218 of the games 100 and 200.

While a feature is available for user election in the example described in relation to FIG. 10, a plurality of features or their combination may be elected by a user.

A game having features of the present disclosure may be played between live players and a ‘house’ in a face-to-face manner, between a live player or live players and a ‘house’ each operating an apparatus having a control console and a video display unit (VDU), between live players each operating an apparatus having a control console and a VDU and a ‘house’ which is an apparatus having processors executing stored instructions, or between players and a ‘house’ each of which is an apparatus having processors executing stored instructions. The ‘house’ herein may be an establishment such as a casino, an apparatus operating as a house or a live dealer representing an establishment without loss of generality.

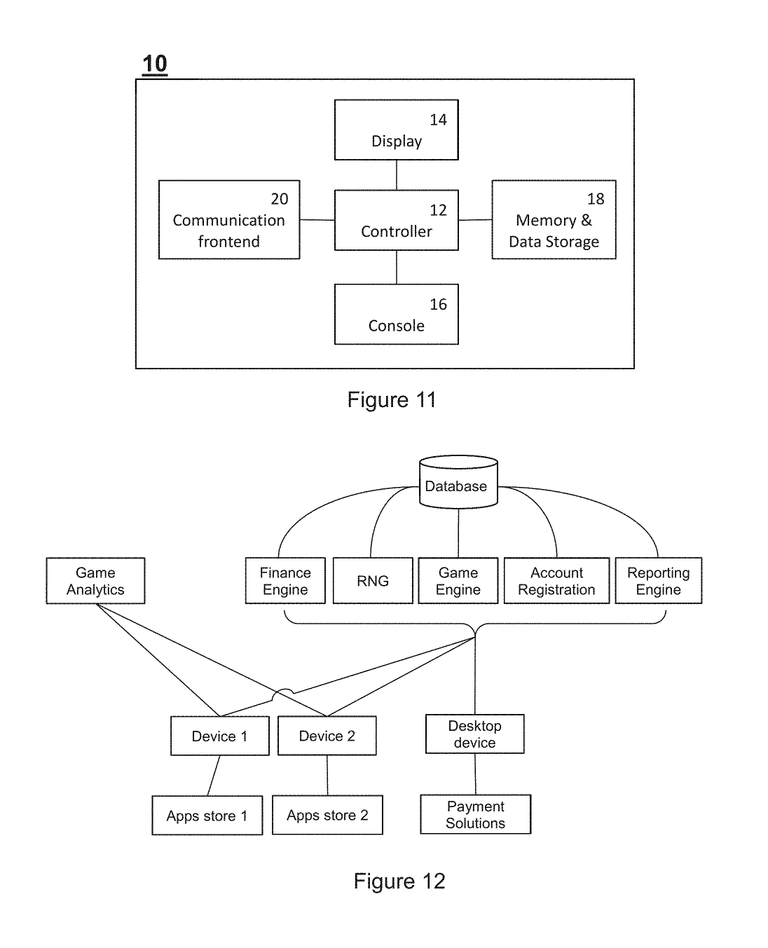

The example game may be played by a user using a gaming apparatus. An example gaming apparatus 10 suitable for playing the game is depicted in FIG. 11, and comprises a controller 12, a display 14, a player console 16, a data storage device 18 and an optional communication frontend 20. The controller is a device operable to control flow of the game and may be a processor or a microprocessor which is operable to execute a set of instructions to facilitate playing of the game. The set of instructions would include instructions to perform rules and features of the game, instructions to facilitate user interaction such as feature selection and activation, user requests, and other useful features. The instructions may be stored locally on a data storage device of the apparatus or in a remote apparatus and obtainable via the communication frontend. The player console is a device to facilitate user interaction with the apparatus or the dealer, such as commencing a game, selecting the number of hands, giving instructions or calls, electing features, etc., and can be a joystick, a keyboard, a mouse, a touch screen, etc. The display is a device to facilitate display of information of the game for user viewing so that a player can view real-time game information when the game is in progress so that responsive steps can be taken. The display may be an LED display such as a touch screen display. The communication frontend may be a wireless telecommunications frontend such as a WiFi frontend, a data communication port, a USB port, etc. to facilitate external communications so that a game may be downloaded or updated, a player may play with remote dealer or remote players on-line.

The gaming apparatus may be a portable apparatus such as a smartphone or a video game machine, a desktop device such as a desktop computer, or a dedicated game station, having a processor to execute an application program of the game.

In some embodiments, the features or the features selector are locked in the first place. In order to earn rights of using these functions, a player is required to meet some conditions. For example, there may be 6 stages in the game and a player is required to attain a certain accumulated winning amount in order to unlock a next stage and the winning amount will be saved as one of the performance data of the player by the system. These conditions may be fulfilled by time, for example, the longer time the player spends on the game, the more right the player may earn. The features may be unlocked one by one. To prevent impulsive behaviour, increasing bet amount will not instantly unlocked these functions but it eventually fastens the whole unlock process. Alternatively, the stages or features may be unlocked or become exercisable based on other conditions such as the total accumulated bet amount of the player, which may also be saved as one of the performance data of the player by the system. In example embodiments, one or more features could be exercised by the player once a predetermined performance threshold or at least one of the performance data is met. The above unlocking manners are merely for reference and shall not be constructed as a limitation of the present disclosure. There may be restrictions on applying the special feature cards. In example embodiments, the player could use only one function in each game and wherein functions like “Reduce points”, “Redraw” and “Win if push” can only be applied once per hand so that the player will need to decide when and whether to apply the function. On the other hand, functions like “peek next card” and “peek dealer's card” can be applied to all hands once selected.

In some embodiments, the House may pay the player to exercise a feature which will change the RTP. For example, the House may pay a portion of the wager back to the player to encourage the player to exercise an adverse option which will decrease the RTP.

In some embodiments, the fee payable to use a feature is set to offset or substantially offset the change in RTP due to the feature.

In some embodiments, the fee payable by a player is comparable to the increase in RTP to compensate for increased risk of the House.

In some embodiments, the fee payable may be set to depend on the instant or current score or range of scores of the player.

In some embodiments, the game may set a variable fee so that a player can exercise or use a feature. The variable fee may be set according to the instantaneous specific RTP (rather than the average RTP) of the player or according to instantaneous specific RTP (rather than the average RTP) of the dealer. Example specific instantaneous RTP values associated with a player's initial scores are depicted in Tables 2-6.

In some embodiments, the fee payable may be by a way of changing in payout when the player wins. For example, the exercise of a feature may be accompanied by a condition that the amount of payout will be reduced. In some embodiments, the reduction in payout may be comparable to the fee payable. In some embodiments, the reduction in payout may be higher to or lower than the fee payable.

In some embodiments, the fee payable may vary according to the feature.

The screen displays of the gaming apparatus which are shown when the game is played may have the appearance of FIGS. 1 to 7B.

For example, after an application program of the game has commenced as depicted in FIG. 1, the controller will operate to display icons on the display representing the dealer's hand, 3 player's hands, a deck of cards, and the bet made by each the player. When a player intends to activate a feature after viewing the player's hand of cards, the player will use the player console and activate the feature menu (marked ‘Function Cards’) to display a menu, a menu will pop up and show a plurality of features available to the player, as depicted in FIG. 2. After the player has elected a feature as depicted in FIG. 3A and paid an activation fee, the elected feature will be activated and the players hand will be updated as depicted in FIG. 3B. Before a feature can be activated, the controller will for example retrieve data representing fund available to the player from the data storage device to determine whether the player has sufficient funds to activate the feature. At the end of the game, the controller will compare scores of the dealer and the player to determine outcome of the game and display on the display, as depicted in FIGS. 3A, 3B, 4A, 4B, 6A and 6B. When the player has activated the peeking feature, the controller will operate to generate an icon showing the next card, as depicted in FIG. 5B.

In some embodiments, the gaming apparatus may be a part of a larger system comprising a plurality of gaming apparatus, payment solutions, game engines connected by the Internet, as depicted in FIG. 12.

While example embodiments have been described herein with reference to the accompanied figures, it would be apparent to those skilled in the art that the method, apparatus, and system described herein are non-limiting examples and various alterations and modifications may be made thereto by those skilled in the art without departing from the spirit teachings or scope of the present application. For example, steps, elements and/or features of various exemplary or illustrative embodiments might be combined with each other and/or substituted for each other within the scope of the present application, which shall all fall into the scope of the present disclosure.

It should be noted that while basic Blackjack has been used as a convenient example, the example is used as a platform to illustrate features and principles of the disclosure and it would be apparent to those skilled in the art that the steps, features, logic and rules are readily applicable to other games such as Poker, Baccarat, Texas Hold'em, Pai Gow, Mahjong, or the like without loss of generality. In fact, the features of reduce points, redraw, peek next card, win if push, and peek dealer's cards as employed in the example game could be readily adaptable to other games mutatis mutandis. When the present disclosure is adapted to games such as Pai Gow, Mahjong, the playing devices would be dominos (or their equivalent graphic icons) instead of playing cards without loss of generality.

Furthermore, while a player is to pay a valuable consideration in order to enjoy the features, the rules may include payments by the host enjoy feature. For example, the host may invite, for example, through the controller, to accept a lower reward when win by paying a valuable consideration.

1-12. (canceled)

13. A gaming apparatus comprising a controller, a display and a player console for a player to play a game with a host, the game having a set of predefined rules to determine scores of a player and a host, and to determine a win situation and a lose situation by comparing scores of a player and a host; wherein the apparatus is operable to deliver an initial set of player devices corresponding to an initial player total score to the player at beginning of the game for viewing by the player on the display, and the player is to make a decision on whether to make a call for another player device or a next player device after getting the initial set of player devices according to the set of predefined rules; wherein the controller by execution of a set of stored instructions is to make available a feature which is exercisable by the player before the player has to decide on whether to make the call, the feature being exercisable by the player upon payment or receipt of a valuable consideration; wherein the apparatus is to perform action predefined by the feature upon detection of a signal indicating exercising of the feature by the player; and wherein exercise of the feature by the player is to result in an apparent increase but an actual decrease in or actual restoration of average return-to-player or long-term probability of winning by the player after taking into account the valuable consideration paid or received by the player.

14. The gaming apparatus according to claim 13, wherein the apparatus is operable to display an initial set of host devices representing an initial host total score on the display, the host total score being not known to or not visible by the player before the call is made; wherein a representation of the feature is displayed on the display for user selection and activation via the player console, and the controller is to monitor the player console to detection the signals representing feature exercising and for making the call.

15. The apparatus according to claim 13, wherein the apparatus is to devise the feature and the valuable consideration such that the player's probability of winning, expressed in terms of return-to-player, is decreased from a higher initial value to a lower resulting value after exercising the feature.

16. The apparatus according to claim 13, wherein the apparatus is to increase the return-to-player after exercising the feature to an apparent return-to-player which is above 1.

17. The apparatus according to claim 13, wherein the apparatus is to set the valuable consideration at beginning of a game before the player is given the initial player devices, the value of consideration correlating to the wager of the player.

18. The apparatus according to claim 13, wherein the set of predefined rules to determine a win situation and a lose situation comprises a score rule that defines a winning score, a bust situation corresponding to the lose situation when the score is above the winning score, and that a party having a higher score closer to the winning score is at the winning situation; wherein the feature includes the player paying the valuable consideration to decrease the initial score or the player receiving the valuable consideration to increase the initial score.

19. The apparatus according to claim 13, wherein the set of predefined rules to determine a win situation and a lose situation includes a score rule that defines a winning score, a bust situation corresponding to the lose situation when the score is above the winning score, and that a party having a higher score closer to the winning score is at the winning situation; where at least one of the host playing devices is a covert device hidden from the player and the feature includes a player paying the valuable consideration to view or peek the covert host device.

20. The apparatus according to claim 13, wherein the set of predefined rules to determine a win situation and a lose situation includes a score rule that defines a winning score, a bust situation corresponding to the lose situation when the score is above the winning score, and that a party having a higher score closer to the winning score is at the winning situation; and wherein the feature includes a player paying the valuable consideration to view or peek the next player device to be given to the player if the player decides to request the next player device is made.

21. The apparatus according to claim 13, wherein the set of predefined rules to determine a win situation and a lose situation includes a score rule that defines a winning score, a bust situation corresponding to the lose situation when the score is above the winning score, and that a party having a higher score closer to the winning score is at the winning situation; and wherein the feature includes a player paying the valuable consideration to have the next player device exchanged by redrawn if the next player device received results result in the bust situation of the player.

22. The apparatus according to claim 13, wherein the set of predefined rules to determine a win situation and a lose situation includes a score rule that defines a winning score, a bust situation corresponding to the lose situation when the score is above the winning score, a tie situation when scores of the player and the host are the same, and that a party having a higher score closer to the winning score is at the winning situation; and wherein the feature includes a player paying the valuable consideration to be in a winning situation or to get back more than the wager when the tie situation arises; wherein the valuable consideration payable to exercise a feature is variable and corresponds to specific RTP of the initial set of player devices.

23. A gaming method comprising a set of predefined rules to determine a win situation and a lose situation by comparing scores of a player and a host, wherein the method comprises giving the player an initial set of player devices representing an initial player total score upon the player paying a wager and the host an initial set of host devices representing an initial host total score at beginning of a game, and the player is to decide on whether to make a call for another player device or a next player device after getting the initial set of player devices; wherein the method comprises providing a feature which is exercisable by the player before making the decision and upon payment or receipt of a valuable consideration, and wherein exercise of the feature by the player is to result in an apparent increase but an actual decrease in average return-to-player or long-term probability of winning by the player after taking into account the valuable consideration paid or received by the player.

24. The method according to claim 23, wherein the method includes devising the feature and the valuable consideration such that the player's probability of winning, expressed in terms of return-to-player, is decreased from a higher initial value to a lower resulting value after exercising the feature.

25. The method according to claim 24, wherein the method includes increasing the return-to-player after exercising the feature to an apparent return-to-player which is above 1.

26. The method according to claim 23, wherein the method includes setting the valuable consideration at beginning of a game before the player is given the initial player devices, the value of consideration correlating to the wager of the player.

27. The method according to claim 23, wherein the set of predefined rules to determine a win situation and a lose situation comprises a score rule that defines a winning score, a bust situation corresponding to the lose situation when the score is above the winning score, and that a party having a higher score closer to the winning score is at the winning situation; and wherein the feature includes the player paying the valuable consideration to decrease the initial score or the player receiving the valuable consideration to increase the initial score.

28. The method according to claim 23, wherein the set of predefined rules to determine a win situation and a lose situation includes a score rule that defines a winning score, a bust situation corresponding to the lose situation when the score is above the winning score, and that a party having a higher score closer to the winning score is at the winning situation; where at least one of the host playing devices is a covert device hidden from the player and the feature includes a player paying the valuable consideration to view or peek the covert host device.

29. The method according to claim 23, wherein the set of predefined rules to determine a win situation and a lose situation includes a score rule that defines a winning score, a bust situation corresponding to the lose situation when the score is above the winning score, and that a party having a higher score closer to the winning score is at the winning situation; and wherein the feature includes a player paying the valuable consideration to view or peek the next player device to be given to the player if the player decides to request the next player device is made.

30. The method according to claim 23, wherein the set of predefined rules to determine a win situation and a lose situation includes a score rule that defines a winning score, a bust situation corresponding to the lose situation when the score is above the winning score, and that a party having a higher score closer to the winning score is at the winning situation; and wherein the feature includes a player paying the valuable consideration to have the next player device exchanged by redrawn if the next player device received results result in the bust situation of the player.

31. The method according to claim 23, wherein the set of predefined rules to determine a win situation and a lose situation includes a score rule that defines a winning score, a bust situation corresponding to the lose situation when the score is above the winning score, a tie situation when scores of the player and the host are the same, and that a party having a higher score closer to the winning score is at the winning situation; and wherein the feature includes a player paying the valuable consideration to be in a winning situation or to get back more than the wager when the tie situation arises.

32. The method according to claim 23, wherein the valuable consideration payable to exercise a feature is variable and corresponds to specific RTP of the initial set of player devices.
